(19) United States
(12) Patent Application Publication
(10) Pub. No.: US 2010/0288985 A1
(43) Pub. Date: Nov. 18, 2010

(54) PIVOT LIFT ASSEMBLY

(76) Inventor: Timothy A. Steensma, Mattawan, MI (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 12/633,275

(22) Filed: Dec. 8, 2009

Related U.S. Application Data
(63) Continuation of application No. 12/456,317, filed on Jun. 15, 2009, now abandoned.
Application No. 12/456,317 is a continuation of application No. 12/288,237, filed on Oct. 17, 2008, now abandoned.
Application No. 12/288,237 is a continuation of application No. 12/072,888, filed on Feb. 28, 2008, now abandoned.
(60) Provisional application No. 60/892,206, filed on Feb. 28, 2007.

(51) Int. Cl. B66F 3/00

(52) U.S. Cl. 254/131

(57) ABSTRACT

A pivot lift assembly (100) is disclosed for use with commercial mowers (12) for lifting front portions of the mowers (12) for purposes of maintenance. The pivot lift assembly (100) includes a universal bracket assembly (102) and mower bracket assembly (124) mounted to the mower (12). A pivot arm assembly (180) is pivotably mounted to a pivot base (160). The pivot arm assembly (180) includes an arcuate lift arm (182) and pivot pin (196). By movement of the mower (12), the pivot pin (196) can be made to releasably engage the universal bracket assembly (102) so as to cause the front end of the mower (12) to lift upwardly.

### CROSS-REFERENCE TO RELATED APPLICATIONS

This application is a continuation of U.S. patent application Ser. No. 12/456,317 filed on Jun. 15, 2009, which is a continuation of U.S. patent application Ser. No. 12/288,237 filed on Oct. 17, 2008, which is a continuation of U.S. patent application Ser. No. 12/072,888 filed on Feb. 28, 2008, which claims priority of U.S. Provisional Patent Application Ser. No. 60/892,206 filed on Feb. 28, 2007.

### STATEMENT REGARDING FEDERALLY SPONSORED RESEARCH OR DEVELOPMENT

Not applicable.

### PARTIES TO A JOINT RESEARCH AGREEMENT

Not applicable.

### REFERENCE TO A SEQUENCE LISTING

Not applicable.

### BACKGROUND OF THE INVENTION

1. Field of the Invention

The present invention relates to a lift for small motorized vehicles and, more particularly, relates to a lift assembly for assistance in performing routine maintenance on vehicles such as commercial lawn mowers.

2. Background Art

Riding lawnmowers require frequent attention to the blades and other components on the undercarriage of the mower. While servicing and repairing lawnmowers and similar small vehicles, it is necessary to work underneath the vehicle, which, due to low clearance has little access while a vehicle is normally parked. Conventional jacks are difficult and time consuming to use. Other types of lift devices have been developed. An object of the present invention is to provide an improved pivot lift that facilitates raising the undercarriage of a riding lawnmower or the like for repair and maintenance purposes.

### BRIEF DESCRIPTION OF THE SEVERAL VIEWS OF THE DRAWING

The invention will now be described with respect to the drawings, in which:

FIG. 1 is a perspective view of a riding lawnmower showing a universal mounting bracket attachable thereto;

FIG. 2 is a perspective side view showing the pivot lift of the present invention in a raised or elevated position;

FIG. 3 is a perspective view of the pivot lift of the present invention, from the perspective of the end of the lift arm;

FIG. 4 is a perspective view of the base of the pivot lift of the present invention from the end of the base;

FIG. 5 is a perspective view of the base of the pivot lift of the present invention from the perspective of the side of the base;

FIG. 6 is a perspective view of the base mounting plate of the present invention;

FIG. 7 is a perspective view of the universal mounting bracket of the present invention;

FIG. 8 is a perspective view of the pivot lift of the present invention, shown in a lowered position;

FIG. 9 is a perspective view showing the base of the pivot lift of the present invention being fitted into the base mounting plate.

FIGS. 10-31 are views of a second and preferred embodiment of a pivot lift assembly in accordance with the invention, with FIG. 10 being a perspective view of a portion of a riding lawn mower, and further showing a perspective view of a substantial portion of a universal bracket assembly, along with one of a pair of mower brackets utilized with the universal bracket assembly;

FIG. 11 is a perspective and relatively “close up” view of one of the mower brackets when assembled on a tubular frame of the mower;

FIG. 12 is a top, plan view of a universal bracket assembly which may be utilized with the preferred embodiment of the pivot lift assembly in accordance with the invention;

FIG. 13 is a front, elevation view of the universal bracket assembly illustrated in FIG. 12;

FIG. 14 is a right-side end elevation view of the universal bracket assembly shown in FIG. 12;

FIG. 15 is a perspective view of a base mounting plate which may be utilized with the pivot lift assembly in accordance with the invention, and with FIG. 15 further showing the relative positioning of the pivot base of the pivot lift assembly as the pivot base would be slidably engaged into and with the base mounting plate;

FIG. 16 is an elevation view of a subset of components of the pivot lift assembly in accordance with the invention, illustrating the pivot arm assembly and its relative positioning with respect to coupling of the pivot arm assembly to the base of the pivot lift assembly;

FIG. 17 is a partially diagrammatic view of the pivot arm assembly in accordance with the invention, and showing the relative positioning with respect to the base and other components of the pivot lift assembly, and further showing the pivot arm assembly in a lowered and “idled” position;

FIG. 18 is a partially diagrammatic view similar to FIG. 17, but showing the pivot arm assembly in a “full-over” position, relative to the base, with the full-over position being one which may be utilized when the pivot lift assembly is coupled to the mower;

FIG. 19 is a partially diagrammatic view of the pivot arm assembly similar to FIG. 18, but with the pivot arm assembly being shown in an “intermediate” position, which also may be utilized as a working position when coupled to the mower;

FIG. 20 is a relatively close up and side elevation view illustrating the lower portion of the lift arm as pivotably secured to side plates of the base, and further showing portions of the safety latch assembly, including the safety latch and the safety latch release spring;

FIG. 21 is a partially diagrammatic view of certain components of the pivot lift assembly, with the view being from the reverse side of the pivot base, relative to the view shown in FIG. 20;

FIG. 22 is an enlarged view of a portion of the illustration of FIG. 21, primarily showing the pivot base, larger side plate, safety latch and adjuster;

FIG. 23 is a relatively close up and perspective view of a lower portion of the pivot lift assembly, showing relative positions of the safety latch, safety latch release spring and lift arm when the lift arm is in a lowered or idle position;

FIG. 24 is a front end view of the pivot base of the pivot lift assembly, and specifically showing the adjuster knob and the positioning of the safety latch release spring when the spring is in an “idle” position;

FIG. 25 is a partially perspective view similar to FIG. 23, but showing the relative position of the safety latch release spring when the spring is moved to an “active” position, and the pivot lift assembly is being moved from a full over orientation, and with the safety latch pin having forces exerted thereon by the safety latch release spring for purposes of movement of the safety latch pin out of one of the safety notches;

FIG. 26 is a perspective and “stand alone” view of a safety latch which may be utilized in accordance with the invention;

FIG. 27 is an elevation view of a safety latch bolt which may be utilized in accordance with the invention, and further showing the insertion of a shear bolt through an aperture near the head of the safety latch bolt;

FIG. 28 illustrates the alignment during assembly of the pivot arm safety latch aperture with the elongated slot of the safety latch;

FIG. 29 is an elevation view showing the insertion of the safety latch bolt through the safety latch slot and through the safety latch aperture of the lift arm;

FIG. 30 illustrates an initial position of the pivot arm assembly relative to the lift arm engagement bracket of the universal bracket assembly; and

FIG. 31 is a perspective view generally illustrating the mower and the pivot lift assembly as the mower is initially driven forward into engagement with the pivot arm assembly.

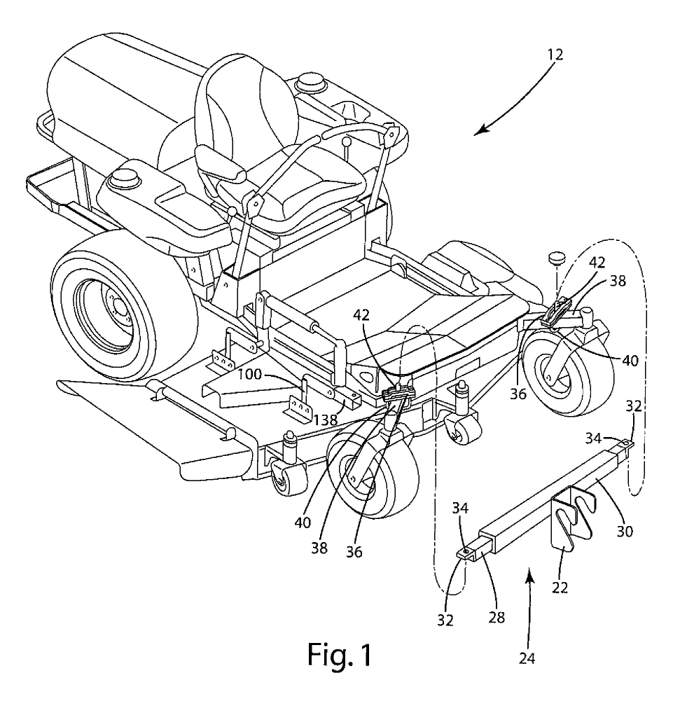

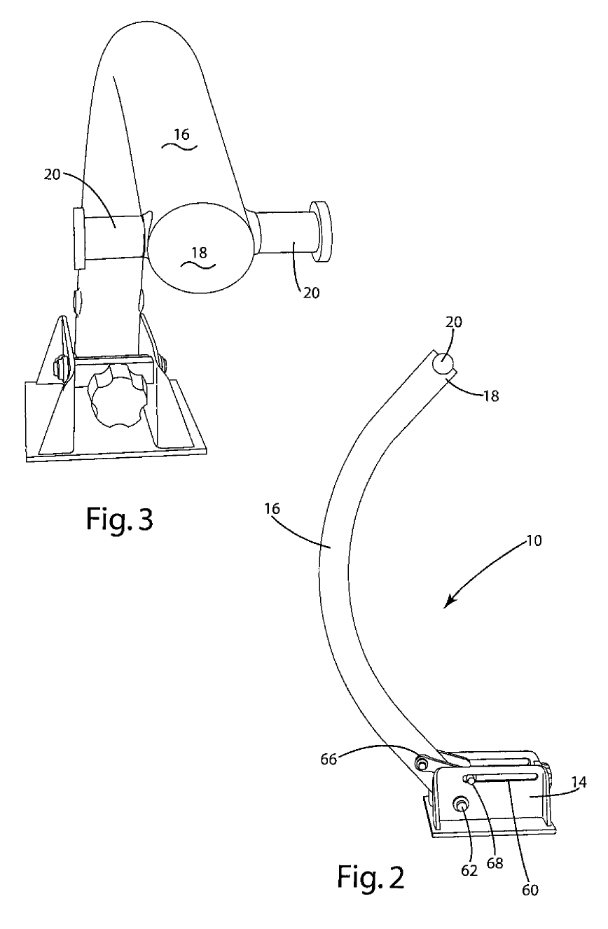

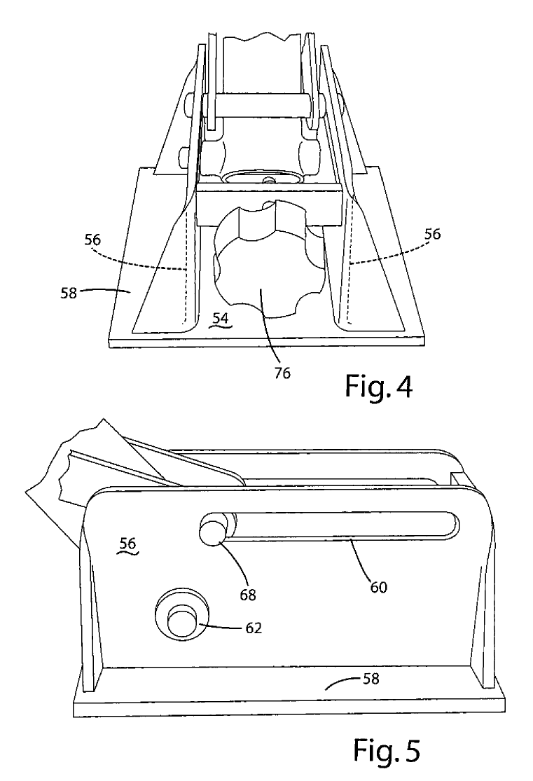

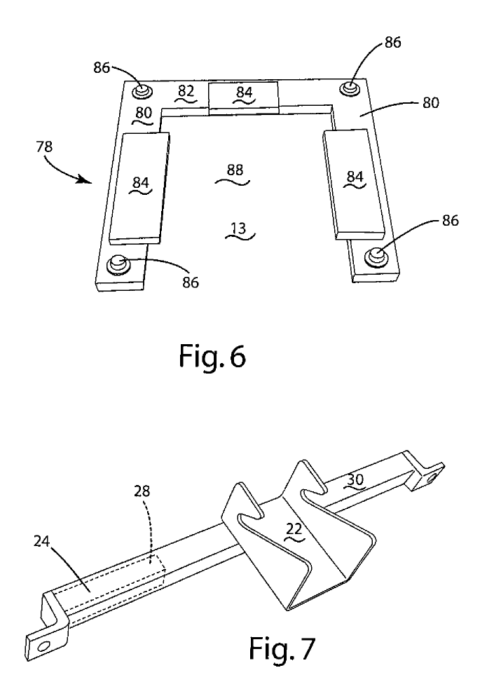

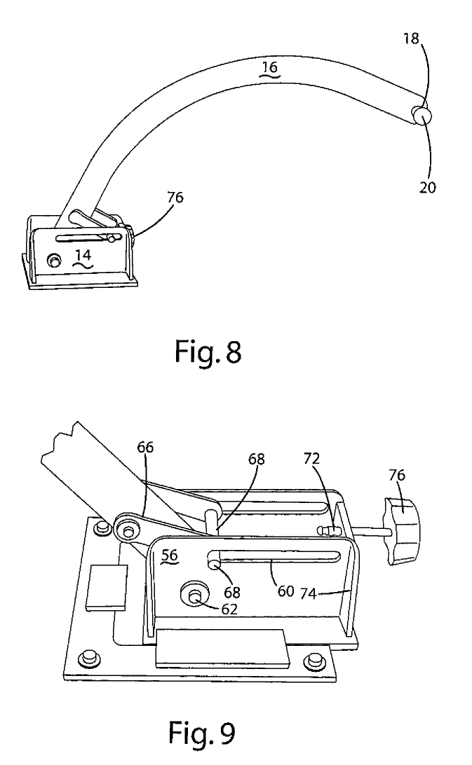

### DETAILED DESCRIPTION OF THE INVENTION

Referring to the drawings, a pivot lift 10 comprises a first embodiment of a pivot lift assembly constructed in accordance with certain aspects of the invention. The pivot lift 10 is designed to easily lift the undercarriage of a vehicle, such as a zero turn radius riding lawnmower 12.

Pivot lift 10 comprises a base 14 and an arcuate lift arm 16, which is pivotally mounted to the base at a lower end 17 and extends to an upper end 18. A pivot pin 20 is transversely mounted in the upper end of the lift arm 16 and extends on opposite sides thereof.

The pivot pin 20 on the upper end of the lift arm is designed to engage a lift plate 22 mounted on a universal mounting bracket 24, which is releasably mounted on the front end of the zero turn radius riding lawnmower 12 shown in the exemplary embodiment.

Universal mounting bracket 24 includes a telescoping transverse tubular shaft 26 having inner and outer sections 28 and 30. Horizontal mounting plates 32 are mounted on the ends of each shaft, with each mounting plate having an opening 34 therein. A mower mounting plate 36 is mounted on a horizontal support member 38 at the front end of each side of the mower by means of U bolts 40 that fit over the horizontal support member in the mower and extend through the mower mounting plates. The mower mounting plates have upwardly extending mounting pins 42 extending upwardly from support members 38. Openings 34 in the horizontal mounting plates attached to the ends of the universal mounting bracket fit over pins 42, and are held in place by locking pins 44.

A lift arm engagement bracket 46 is mounted at the center of the telescoping shaft 26 of the universal mounting bracket 24. Engagement bracket 46 is U-shaped and includes a pair of transversely spaced vertical plates 48 having upwardly and inwardly inclined pivot pin engagement surfaces 50 thereon that lead to arcuate sockets 52 at the upper ends of the inclined surfaces. Surfaces 53 at the front sides of the sockets are also upwardly and inwardly inclined.

Base 14 of the pivot lift comprises a flat, horizontal base plate 54, with spaced vertical plates 56 mounted on an upper side thereof and spaced inwardly from side edges 58 of the base plate. Vertical plates 56 include horizontal slots 60 at an upper portion thereof. Pivot mounting pins 62 extend through openings 64 positioned below the horizontal slots 60 at one end thereof. Pivot mounting pins also extend through the lower end of lift arm 16, which is positioned between plates 56. Support arms 66 are pivotally mounted to each side of the lift arm above the position of pivot mounting pins 62. Arms 66 extend to outer ends that are mounted to a transverse pin 68 that extends through both arms and extends outwardly through slots 60 in plates 56. An adjustment screw 72 is threaded in a vertical end plate 74 on the base into an inner end that contacts transverse pins 68 on the ends of arms 66. An exterior knob 76 on the outer end of screw 72 can be rotated to change the engagement point of screw 72 with adjustment plate 70. This adjusts the vertical position of the upper end of the pivot arm at its lowermost position.

Base 14 is attached to a horizontal support surface, such as a floor 13, by means of a U-shaped base mounting plate 78. Base mounting plate 78 includes spaced transverse side rails 80 and a back rail 82. Support flanges 84 extend inwardly from the side rails and back rail at positions adjacent the upper side of the mounting plate 78. Mounting plate 78 is attached to a floor surface by means of bolts 86. The base mounting plate could be attached to the floor of a pickup truck or to a plywood board or other movable support surface for mounting the lift mechanism in the back of a pickup truck or for providing for movement of the lift mechanism to other locations.

The base plate 54 of the pivot lift fits in the open interior 88 of the U-shaped mounting plate, with protruding side edges 58 at the base plate fitting under support flanges 84. The base plate can thus be slipped into supporting engagement with an anchored base plate for use of the lift mechanism and can be removed from the base plate for storage elsewhere after the use of the device is completed. The user can also acquire multiple base mounting plates for mounting the pivot lift in various locations, and each of the base plates can be left in position when the device is not being used. The base mounting plates provide a rigid, fixed support for the pivot lift without presenting a vertical obstruction when the pivot lift is not being used and is removed from that location.

The pivot lift of the present invention is particularly well-suited for use in lifting a riding lawnmower known as a zero turning radius riding lawnmower. This device is driven by a gasoline motor through a hydraulic drive mechanism. The hydraulic drive mechanism is significant because the hydraulic drive mechanism provides a very substantial braking force when the drive is not engaged.

The manner in which the present invention is used for lifting a riding lawnmower of this type is as follows:

The base of the pivot lift is anchored in place in a suitable base support plate by simply sliding the base of the pivot lift into the opening in the base mounting plate. The resting or lowered position of the pivot pins 20 on the upper end of the lift arm is adjusted by rotating knob 76 on adjustment screw 72. This raises or lowers the positions of pivot pins 20. These pins should be adjusted so that they are aligned with the inclined pivot pin engagement surfaces 50 on the lift arm engagement bracket. The advantage of the inclined surfaces is that they provide an elongated engagement range for the lift arm.

To lift the riding mower, the inclined surfaces 50 on the lift arm engagement bracket are simply driven against the pivot pins 20 on the upper end of the lift arm. Pivot pins 20 are first driven upwardly on the inclined surface into engagement with the sockets 52 at the upper ends of the inclined surfaces. When firmly engaged in the sockets, further movement of the vehicle causes the pivot arm to pivot upwardly, lifting the vehicle as the arm pivots upwardly. The vehicle can be stopped at any point up to an upper position, wherein the arm is positioned in a slightly over center position. The vehicle is then locked in place by the emergency brake on the vehicle and also by the inherent braking force of the hydraulic drive mechanism when in its deactuated condition.

An important feature of the present invention is the manner in which the vehicle is removed from the lift mechanism. When the repairs are completed, the parking brake is disengaged, and the vehicle is moved slightly rearwardly. The inherent braking force of the hydraulic drive mechanism prevents the vehicle from rolling rapidly backwardly. Instead, the vehicle slowly rolls rearwardly as the pivot arm pivots from an upper position to its lower position. An upper surface 51 of the socket is downwardly and outwardly inclined, so that the pivot pins are urged downwardly out of engagement with the socket, as the vehicle is backed away from the lift mechanism.

An important feature of the present invention is the curved design of the lift arm. The curve in the lift arm creates an offset portion of the arm that allows clearance between the riding mower and the lift arm, through the full travel of the lift arm from its lowered to its raised position. If the lift arm were straight, the arm would make contact with the riding mower well before the machine gets to its full height.

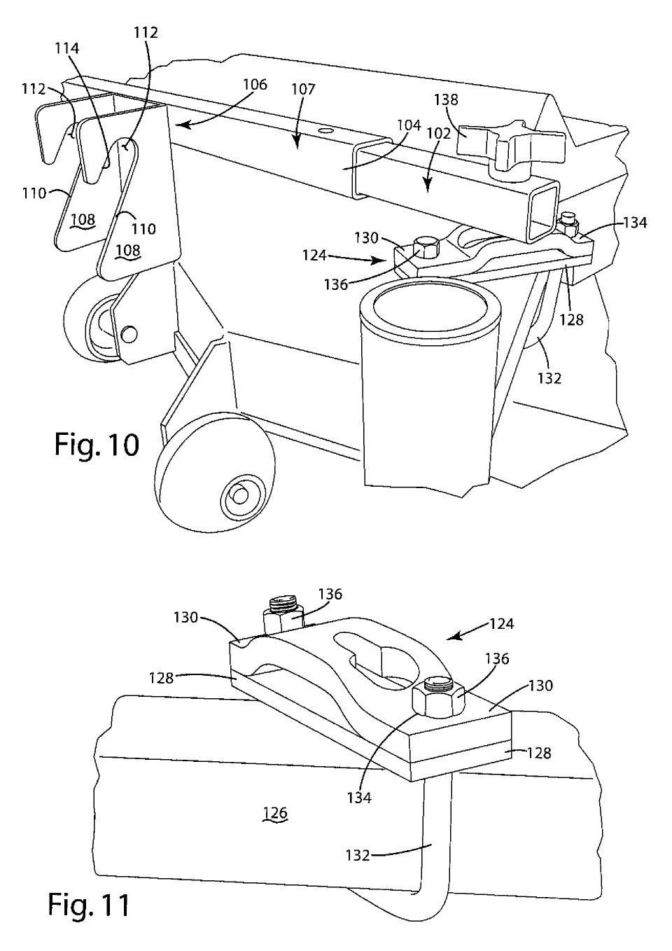

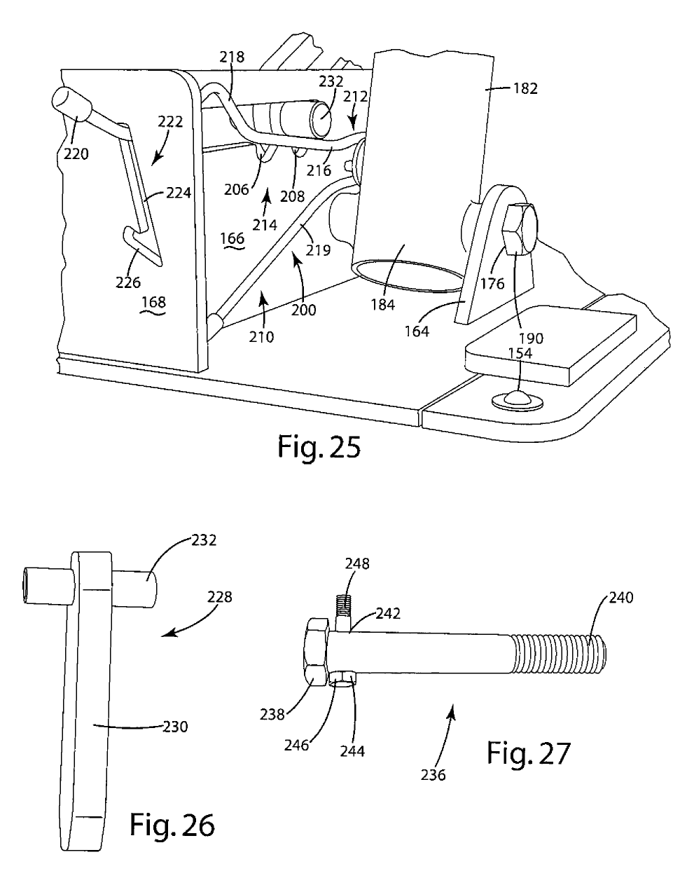

The forgoing paragraphs described a first embodiment of a pivot lift assembly 10 in accordance with the invention. Certain principles of the invention will now be described with respect to a second embodiment of a pivot lift assembly 100, as illustrated in FIGS. 10-31. The applicants believe that the second embodiment of the pivot lift assembly 100 is a preferred embodiment over the pivot lift assembly 10 as previously described herein. However, a number of novel and inventive concepts in accordance with the invention are common to both embodiments.

The pivot lift assembly 100 is adapted to function with a number of small commercial vehicles, such as the riding lawn mower 12 previously described herein with respect to the pivot lift 10. The pivot lift assembly 100 is further adapted to be used with a universal bracket assembly 102. As shown in FIGS. 10, 12, 13 and 14, the bracket assembly 102 includes a central tubular frame 104 which may have a rectangular cross-sectional configuration. The universal bracket assembly 102 further includes a lift arm engagement bracket 106 located on one side of the central tubular frame 104. The lift arm engagement bracket 106 may be integral with the central tubular frame 104. As shown in the drawings, the lift arm engagement bracket 106 preferably has a U-shaped configuration, and includes a pair of transversely spaced vertical plates 108. Formed on the vertical plates 108 are a pair of pivot pin engagement surfaces 110. The pivot pin engagement surfaces 110 have an upwardly and inwardly inclined orientation, leading to arcuate sockets 112 at the upper ends of the inclined surfaces 110. The sockets 112 are primarily shown in FIGS. 10 and 14. The front sides of the arcuate sockets 112 are formed by front surfaces 114, with the front surfaces 114 also being upwardly and inwardly inclined.

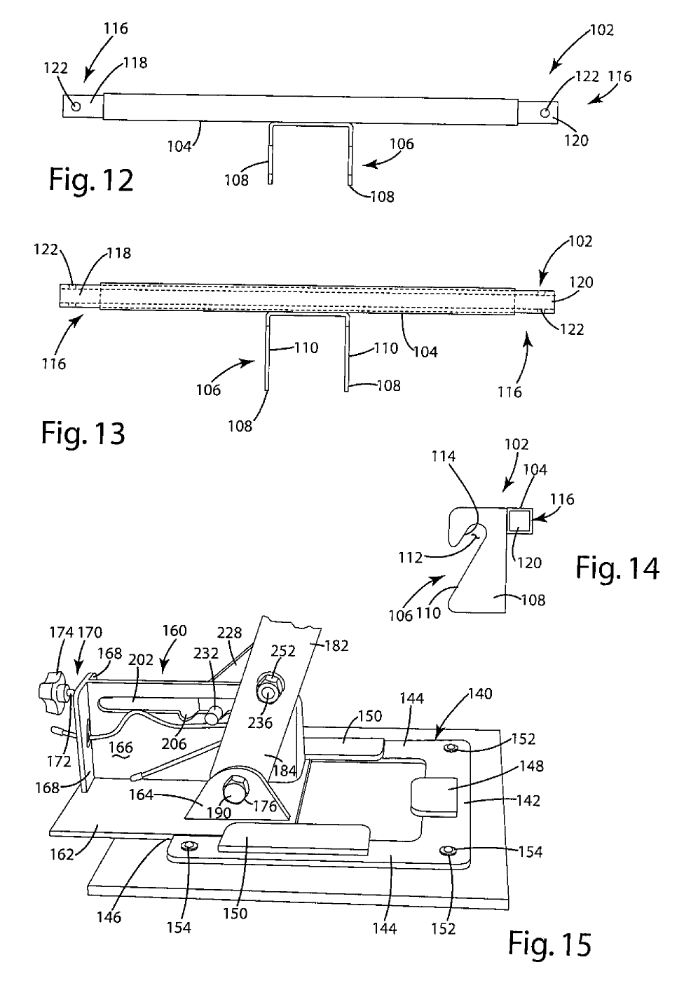

In addition to the central tubular frame 104 and the lift arm engagement bracket 106, the universal bracket assembly 102 further includes a pair of telescoping adjustable arms 116, moveable within the interior of the central tubular frame 104. The pair of telescoping adjustable arms 116 includes a first adjustable arm 118 and a second adjustable arm 120. As shown primarily in FIGS. 12 and 13, each of the adjustable arms 118, 120 can move outwardly and inwardly in opposing directions within the central tubular frame 104. Extending through the top and bottom portions of each of the adjustable arms 116, and located at the ends thereof, are a pair of threaded apertures 122. As will be described in subsequent paragraphs herein, the lift arm engagement bracket 106 is adapted to receive a pivot pin on a lift arm of the pivot lift assembly 100 for purposes of providing lifting forces on the riding lawn mower 12 when the universal bracket assembly is mounted to the mower 12.

More specifically, for purposes of mounting the universal bracket assembly 102 to the lawn mower 12, additional components are utilized, which are referred to herein as mower bracket assemblies 124. The mower bracket assemblies 124 serve substantially the same purpose as the mower mounting plates 36 previously described with respect to the pivot lift 10. More specifically, the pivot lift assembly 100 utilizes a pair of the mower bracket assemblies 124, with each of the bracket assemblies 124 mounted to opposing sides of the front portion of the mower 12. One of the pair of mower bracket assemblies 124 is illustrated in both FIGS. 10 and 11. With the embodiment of the pivot lift assembly 100 described herein, it is assumed that the mower 12 includes a tube frame 126 (FIG. 11) which may connect front casters of the mower 12 to a forward portion of the frame or foot pedestal. Further, for use of the specific pivot lift assembly 100 described herein, it is preferable that this portion of the tube frame 126 be running somewhat perpendicular to the deck of the mower 12. If the arm which connects to the front casters happens to run relatively horizontal to the mower deck, then the universal bracket assembly 102 may need to be somewhat modified.

Assuming that the tube frame 126 is appropriately oriented on the mower 12, the mower bracket assemblies 124 can be fitted along any of a number of desired locations on the tube frame 126. For purposes of assembly and operation, it has been found that it is best to position the mower bracket assemblies 124 as close as reasonably possible to the front casters of the mower 12. With reference specifically to FIGS. 10 and 11, each of the mower bracket assemblies 124 includes a spacer plate 128 (one of which is shown in FIGS. 10 and 11). The spacer plate 128 has a rectangular and flat configuration, and is positioned on the top of the tube frame 126. A mower bracket 130 is then positioned above the spacer plate 128, so that the spacer plate apertures 134 align with apertures (not shown) in the spacer plate 128. A threaded U-bolt 132 is then positioned below the tube frame 126, with its legs extending upwardly on opposing sides of the frame 126. The legs of the U-bolt 132 are then received within the mower bracket apertures 134 and the spacer plate apertures (not shown) in the spacer plate 128.

For purposes of installation, it is preferred that each mower bracket assembly 124 be “rotated” across the tube frame 126 as far as reasonably possible, so that the U-bolt 132 is as tight as possible against the sides of the tube frame 126. When the mower bracket assemblies 124 have been appropriately positioned on the tube frame 126, the universal bracket assembly 102 can be positioned across the front of the mower 12, and above the mower bracket assemblies 124. This “checking” activity should be undertaken so as to ensure that the universal bracket assembly 102 is running substantially horizontal to the deck of the mower 12. The mower bracket assemblies 124 can be adjusted as required so as to achieve this horizontal orientation. When each mower bracket assembly 124 is appropriately positioned, the mower bracket nuts 136 can be tightened so as to essentially “lock” the mower bracket assemblies 124 to the tube frame 126. If desired, excess portions of the legs of the U-bolts 132 can be cut off so that the ends are substantially flush with the mower bracket nuts 136.

For purposes of installing the universal bracket assembly 102 on the mower 12 and the mower bracket assemblies 124, the central tubular frame 104 can be positioned above and intermediate to the pair of mower bracket assemblies 124 at the front of the mower 12. Each of the pair of telescoping adjustable arms 116 can be fitted with threaded universal bracket knobs 138 which can be threadably received within the threaded apertures 122 at the ends of each of the adjustable arms 118, 120. One of the threaded universal bracket knobs 138 is illustrated in FIG. 10. When the adjustable arms 118, 120 have been appropriately extended, the threaded apertures 122 will align with threaded apertures (not shown) on each of the mower brackets 130. When appropriately aligned, the threaded universal bracket knobs 138 can be threadably extended so as to be received into threaded mower bracket apertures (not shown) associated with each of the mower brackets 130. When the knobs 138 are appropriately tightened, the universal bracket assembly 102 and the mower bracket assemblies 124 are installed and assembled on the mower 12.

The pivot lift assembly 100 in accordance with the invention also includes a base mounting plate 140 as primarily shown in FIG. 15. The base mounting plate 140 has a U-shaped configuration and is adapted to provide for a secure and stationary mounting base for the pivot lift assembly 100. The base mounting plate 140 includes a front section 142, with a pair of parallel and opposing sides 144. Between the ends of the sides 144 is an open section 146. The open section 146 is utilized to provide a means for slidable engagement of the principal components of the pivot lift assembly 100 into a secured position within the base mounting plate 140. As further shown in FIG. 15, an offset and raised plate 148 is secured to or is otherwise integral with the front section 142. Correspondingly, the base mounting plate 140 also includes a pair of offset and raised plates 150, extending inwardly from each of the opposing sides 144. The areas below the offset portions of the plates 148, 150 provide the means for capturing the base of the principal components of the pivot lift assembly 100. As further shown in FIG. 15, the base mounting plate 140 is preferably secured to a floor (or other surface, such as a truck vehicle bed or the like) through the use of anchors 152 or similar means. If anchors 152 are utilized, the base mounting plate 140 can be secured thereto through the use of washer/nut combinations 154. In FIG. 15, the main portion of the pivot lift assembly 100 is shown as being partially positioned (through slidable engagement) within the base mounting plate 140 under the offset areas of the raised plates 148, 150. Of course, it will be apparent that numerous types of mounting structures can be utilized, without departing from the spirit and scope of the principal novel concepts of the invention.

As shown in a number of the drawings, including FIGS. 15-25, the pivot lift assembly 100 further includes a pivot base 160, shown in particular in FIG. 15. The pivot base 160 provides a stationary means and support for certain of the principal elements of the pivot lift assembly 100. With reference to the drawings, the pivot base 160 includes a horizontal stand 162, again primarily shown in FIG. 15. The horizontal stand 162 is a substantially rectangular and flat section which is adapted to slide into the base mounting plate 140 as previously described herein. Extending upwardly (and, if desired, integral therewith) from the stand 162 are a pair of sideplates, including a clevis-like small side plate 164 having a curved outer surface, and a parallel and relatively larger rectangular side plate 166. At the front portion of the horizontal stand 162 is a front plate 168 extending upwardly therefrom, which may be integral with the relatively larger side plate 166 and positioned perpendicular with respect thereto. An adjuster 170 is coupled to the front plate 168. The adjuster 170 is particularly shown in FIG. 22. More specifically, the adjuster 170 includes an adjuster screw 172 which is threadably received within an aperture (not shown) extending horizontally through the front plate 168. An adjuster knob 164 is secured to an outer end of the adjuster screw 172. As will be apparent from subsequent description herein, the adjuster 170 provides a means for accurately positioning certain components of the pivot lift assembly 100 at an appropriate height for engagement with the universal bracket assembly 102 mounted to the mower 12.

Extending horizontally through the clevis-like small sideplate 164 is a first pivot arm bolt aperture 176, illustrated in part in FIG. 15 and other drawings. A second pivot arm bolt aperture 178 is aligned in a coaxial configuration with the first pivot arm bolt aperture 176, and extends through the relatively large sideplate 166.

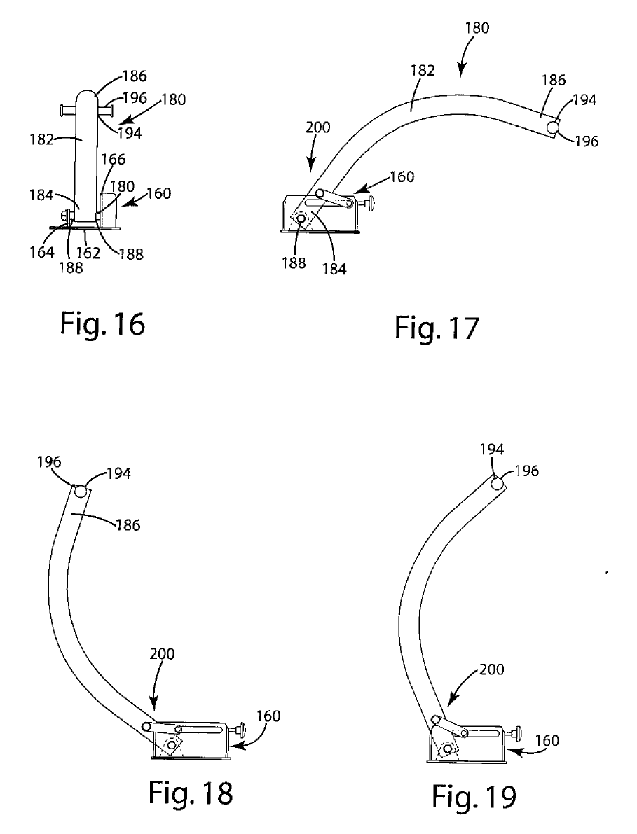

As previously described with respect to the pivot lift 10, a pivot or lift arm is incorporated within pivot lift assemblies in accordance with the invention. For the pivot lift assembly 100, a pivot arm assembly 180 is included, which is shown in several of the drawings, including FIGS. 15-19. The pivot arm assembly 180 includes an arcuate pivot lift arm 182 having the general shape and configuration as primarily shown in FIGS. 17, 18 and 19. The arcuate pivot lift arm 182 comprises a lower end 184 and an upper end 186. Extending through the lower end 184 of the arcuate pivot lift arm 182 is a lift arm bolt aperture 188, shown in FIG. 16. For pivotably coupling the pivot arm assembly 180 to the pivot base 160, a pivot arm bolt 190 is inserted through the first pivot arm bolt aperture 176 of the clevis-like small side plate 164. The lift arm bolt aperture 188 is then manually aligned with the first pivot arm bolt aperture 176 and the pivot arm bolt 190 is passed therethrough, and further extends through the second pivot arm bolt aperture 178 located in the relatively larger side plate 166. A lock nut 192 (FIG. 22) can then be secured to the threaded end of the pivot arm bolt 190, thereby securing the arcuate pivot lift arm 182 to the pivot base 160. For purposes of appropriate installation and assembly, the nut 192 can be tightened onto the bolt 190 so as to be relatively snug, but still allow the arcuate pivot lift arm 182 to freely pivot about the pivot arm bolt 190.

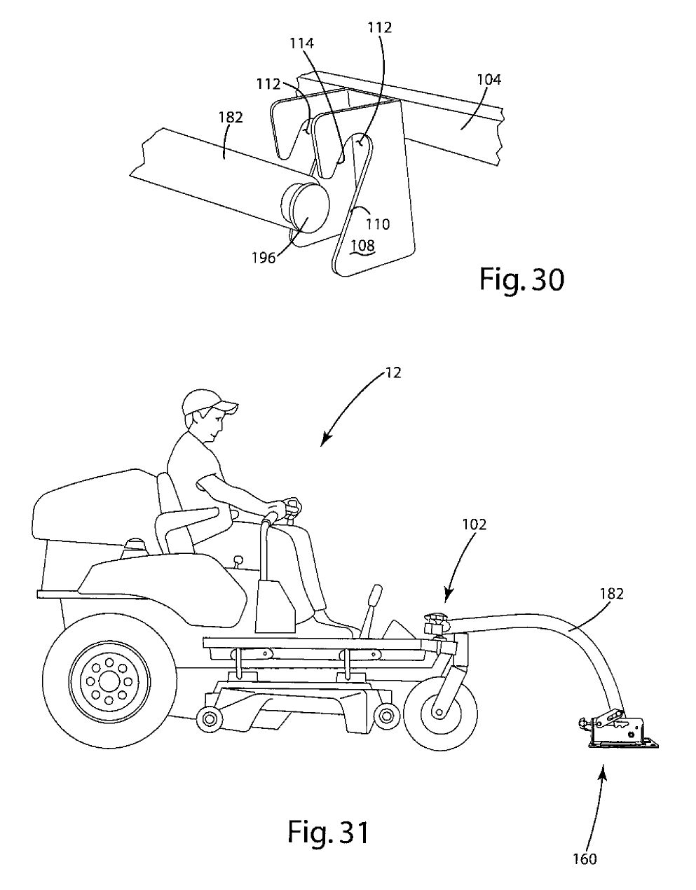

Located at the upper end 186 of the arcuate pivot lift arm 182 is a pivot pin aperture 194 (FIGS. 17, 18 and 19). The pivot pin aperture 194 extends transversely through the arcuate lift arm 182. A pivot pin 196 (shown in FIGS. 16 and 30, among other drawings) can then be appropriately secured (by any suitable means) through the pivot pin aperture 194. The pivot pin 196 provides a means for releasably coupling the pivot arm assembly 180 to the universal bracket assembly 102 during lifting operations of the mower 12. The pivot pin 186 should be of appropriate strength and length so as to be releasably captured within the arcuate sockets 112 of the lift arm engagement bracket 106 previously described herein.

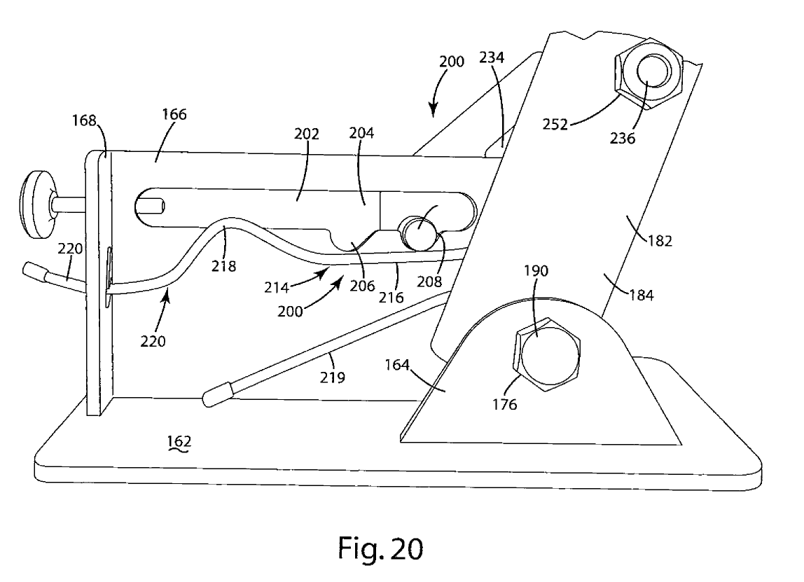

The pivot lift assembly 100 in accordance with the invention also includes what could be characterized as a safety latch assembly 200. The safety latch assembly 200 is generally shown in several views of the drawings, including FIGS. 20-25. Individual components of the safety latch assembly 200 are further illustrated in FIGS. 26-29. The safety latch assembly 200 operates so as to provide a means for facilitating the capability of maintaining the mower 12 in a desired “lifted” position during use of the pivot lift assembly 100. For purposes of use of the safety latch assembly 200, and as shown in particular in FIGS. 20, 21 and 22, the relatively large side plate 166 of the pivot base 160 includes a plate slot 202 having a horizontal orientation and extending in an elongated manner from the back area to the front area of the large side plate 166. As further shown in the drawings, a pair of plate notches 204 are located below the plate slot 202 and open thereto near one side of the plate slot 202. The plate notches 204 can be characterized as including an intermediate notch 206 and a “full-over” notch 208. The purpose and function of the plate slot 202 and the plate notches 204 will become apparent from subsequent description herein.

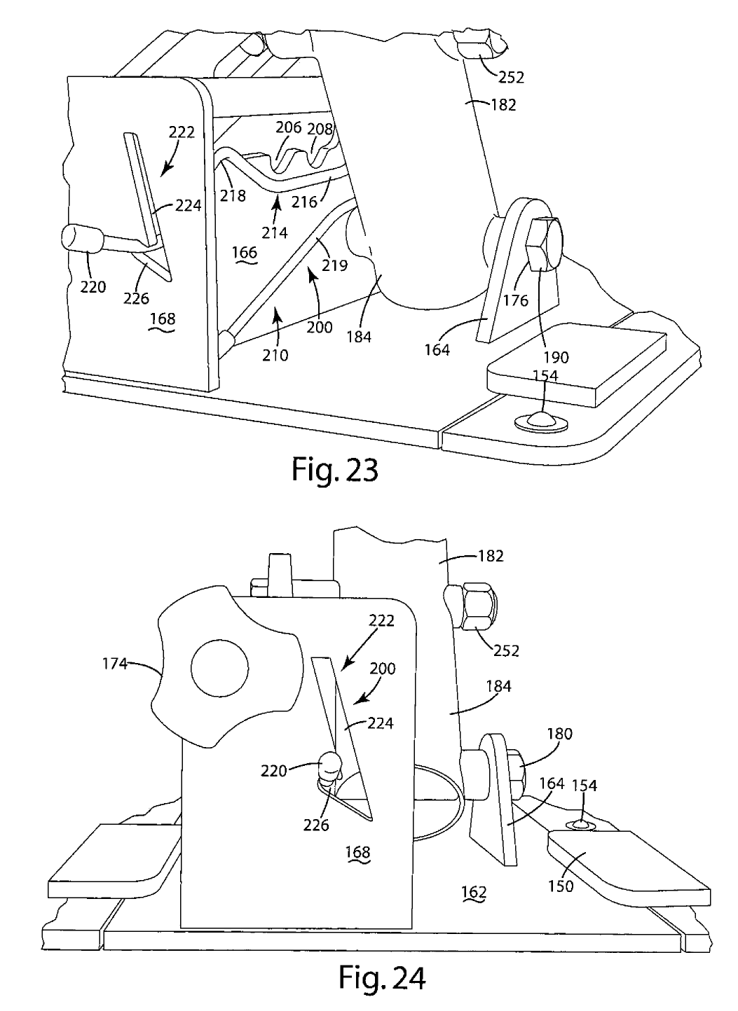

The safety latch assembly 200 also includes a resilient safety latch release spring 210, primarily shown in FIGS. 20, 23 and 25. The release spring 210 is fixedly secured to one side of the arcuate lift arm 182 at the lower end 184 thereof, through a coupling bracket 212 positioned slightly above the lift arm bolt aperture 188. The safety latch release spring 210 includes an upper spring section 214 extending from the coupling bracket 212 to the front plate 168 of the pivot base 160. Extending downwardly at an angular configuration from the coupling bracket 212 is a lower support leg 219. The lower support leg 219 provides a supporting base for the release spring 210. The upper spring section 214 includes a pin support section 216 adjacent the coupling bracket 212. Extending from and integral with the support section 216 is an arcuate section 218. Extending from the arcuate section 218 of the upper spring section 214 is a spring handle 220. The spring handle 220 is primarily shown in FIGS. 23 and 24. A V-shaped aperture 222 extends horizontally through the front plate 168 of the pivot base 160. This V-shaped aperture 222 is primarily shown in FIGS. 23 and 24. The aperture 222 includes a first aperture leg 224 and a second aperture leg 226. The spring handle 220 can be manually positioned within either the first aperture leg 224 or the second aperture leg 226. When the spring handle is in the first aperture leg 224, the support section 216 of the spring 210 is exerting upwardly directed forces on a pin of a safety latch to be described subsequently herein. When the spring handle 220 is positioned within the second aperture leg 226, tension forces from the support section 216 are removed from the safety latch components.

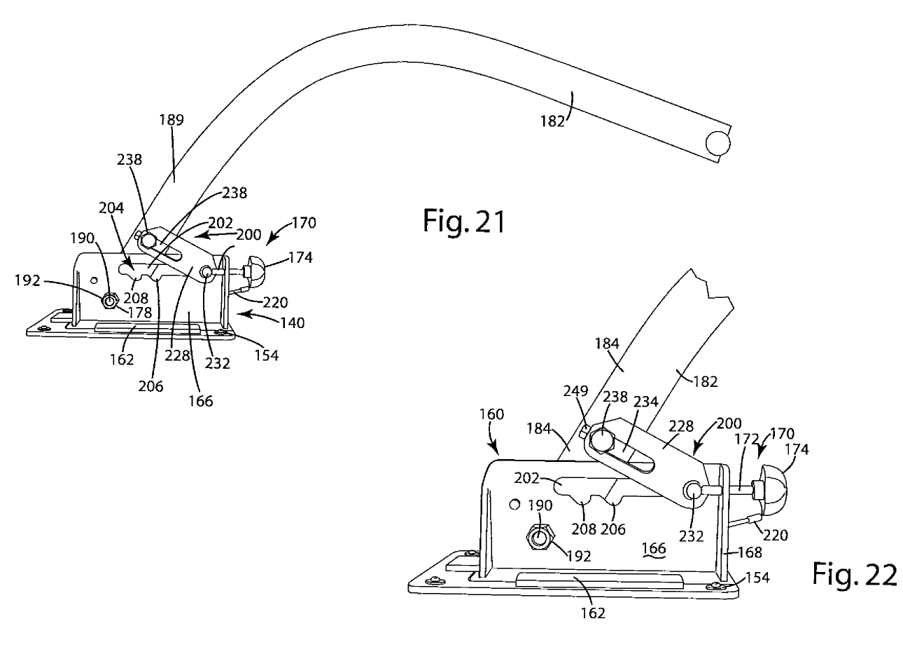

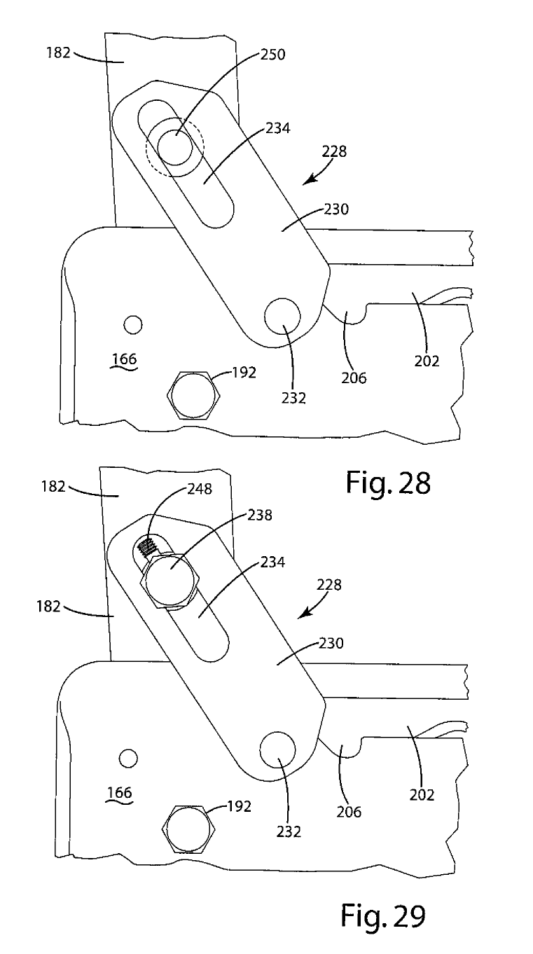

The safety latch assembly 200 further includes a safety latch 228 having a configuration as primarily shown in FIGS. 21, 22 and 26. More specifically, the safety latch 228 includes an elongated section 230. A safety latch pin 232 extends transversely through one end of the elongated section 230. Also extending horizontally through the elongated section 230 is a safety latch slot 234, as shown in particular in FIGS. 21 and 22. For purposes of installation and assembly of the safety latch assembly 200, the safety latch release spring 210 can be positioned so that the spring handle 220 is received within the second aperture leg 226 (FIGS. 23 and 24) of the V-shaped aperture 222 in the front plate 168. The safety latch 228 can then be assembled by inserting the safety latch pin 232 through the plate slot 202 of the relatively large side plate 166. This assembly is shown in FIG. 28. The safety latch pin 232 can include a push retainer or similar means for purposes of securing the pin 232 within the plate slot 202.

The pivot lift assembly 100 and, more specifically, the safety latch assembly 200 further includes a safety latch bolt 236, shown in its entirety in elevation view in FIG. 27. The safety latch bolt 236 includes a head 238 and threaded section 240 at the opposing end from the head 238. Extending transversely through the safety latch bolt 236 is a shear bolt aperture 242. A relatively shorter shear bolt 244 having a head 246 and threaded section 248 is inserted into the shear bolt aperture 242, and secured with a nut 249 (FIG. 22) received on the threaded section 248. The shear bolt 244 provides additional safety features, and will facilitate a shearing effect if the pivot lift assembly 100 is improperly used.

For purposes of appropriate assembly of the safety latch assembly 200 with the pivot lift assembly 100, a safety latch lift arm aperture 250 (FIG. 28) extends transversely through the lower end 184 of the arcuate lift arm 182. The safety latch lift arm aperture 250, for purposes of assembly, is aligned with the safety latch slot 234, as further shown in FIG. 28. The installer can then insert the safety latch bolt 236 through the safety latch slot 234 and through the safety latch lift arm aperture 250 within the arcuate lift arm 182. The safety latch bolt 236 can then be secured within the safety latch lift arm aperture 250 through the use of a nut 252 as shown in FIG. 24. Preferably, the nut 252 is a nylon lock nut. For appropriate assembly, it is recommended that the nylon lock nut 252 be tightened until the safety latch 228 begins to tighten up against the arcuate lift arm 182. The lock nut 252 should then preferably be backed off until the safety latch assembly 200 can move freely relative to the arcuate lift arm 182.

A brief description of the operation of the pivot lift assembly 100 will now be provided in subsequent paragraphs herein. When in practical use, it is believed that it is preferable for a functional check out to be performed by the operator, so as to ensure proper operation. For this purpose, the arcuate lift arm 182 can be raised from its idle or lower most position (shown in FIG. 17), until the safety latch pin 232 essentially “drops in to” the intermediate notch 206 of the plate notches 204. The resilient release spring 210 can then be depressed by moving the handle 220 to the right side (as viewed in FIG. 24) so that the handle 220 moves from the second aperture leg 226 to the first aperture leg 224. With this movement, forces should be exerted on the safety latch pin 232 by the support section 216 of the release spring 210, so as to release the pin 232 from the intermediate notch 206. The arcuate lift arm 182 can then be lowered (back to the position shown in FIG. 17) to the position where the pin 232 abuts the adjuster screw 172 of the adjuster 170 (this position being shown in FIG. 22). With the particular shape and configuration of the release spring 210, this movement should cause the release spring 210 to be automatically reset into its locked position. This occurs as a result of the pin 232, as it moves back to its start position, exerting downwardly directed forces on the arcuate section 218 of the spring 210. If desired, this check out cycle can then be repeated by moving the arcuate lift arm 182 to the full over position as shown in FIG. 19, with the pin 232 then engaging the full over notch 208.

When in actual use, it should be noted that the telescoping adjustable arms 116 have likely been extended outwardly from the central tubular frame 104. For purposes of ensuring that these arms 116 are not extended to a length which could potentially cause damage through transverse forces exerted on the arms 116 relative to the central tubular frame 104, it is preferable if some type of “warning” components are associated with the adjustable arms 116, so as to warn the installer or operator when the arms 116 are being moved too far out of the central tubular frame 104. For example, one means of providing such warning would be to paint the innermost several inches of the adjustable arms 116 a different color. In this manner, if any portion of this different color is showing when the universal bracket assembly 102 has been installed, it will indicate a dangerous condition.

Before actual engagement of the pivot arm assembly 180 with the universal bracket assembly 102, the operator should ensure that the “idle” or “stop” position (shown in FIG. 17) of the pivot arm assembly 180 is set to a proper height so as to engage the universal bracket assembly 102. This height can be adjusted through the use of the adjuster 170. As apparent from FIG. 22, adjustment of the adjuster 170 will cause the threaded portion 172 of the adjuster 170 to exert forces against the pin 232, thereby causing the safety latch assembly 200 to maintain the arcuate lift arm 182 at a selected position.

After ensuring that the pivot arm assembly 180 is at a proper height, the operator can drive the mower 12 forward so as to appropriately align the lift arm engagement bracket 106 with the pivot pin 196 of the pivot arm assembly 180. This initial position is illustrated in FIG. 30. As the motor 12 is driven forward, the pivot pin 196 will engage the pivot pin engagement surfaces 110 of the engagement bracket 106. Further movement will cause the pivot pin 196 to essentially “ride up” the engagement surfaces 110 (thereby lifting the lift arm 182) until the ends of the pivot pin 196 are captured within the arcuate sockets 112 of the engagement bracket 106. As the mower 12 is continued to be driven forward under idle power, the forces exerted on the pivot arm assembly 180 by the mower 12 and the corresponding forces exerted on the lift arm engagement bracket 106 by the pivot pin 196 will cause the arcuate lift arm 182 and the front of the mower 12 to simultaneously lift upwardly, with the arcuate lift arm 182 pivoting about the pivot arm bolt 190 which extends through the lift arm bolt aperture 188 (FIG. 16). This movement will continue until the pin 232 drops into the intermediate notch 206. This would correspond to the arcuate lift arm 182 being in the intermediate position illustrated in FIG. 19. The initial position of the mower 12 during this lifting operation is illustrated in FIG. 31. If it is desired to position the mower 12 at a greater height, the mower 12 can be driven further forward so that the pin 232 moves out of the intermediate notch 206 and into the full over notch 208. The pin 232 being in the full over notch 208 would correspond to the arcuate lift arm 182 being in the full over position illustrated in FIG. 18.

If the operator inadvertently “over drives” the mower 12, the safety latch assembly 200 will operate so that the safety latch 228 may actually move sufficiently so that the pin 232 reaches the back of the plate slot 202. At this point, the operator would sense a substantial resistance to further forward movement of the mower 12. Further, for purposes of safety, the safety latch assembly 200 also functions so as to attempt to prevent damage in the event the mower 12 would be moved too far in a reverse direction. That is, reversing the mower 12 too far can cause the safety latch shear bolt 244 to actually shear.

When it is desired to lower the mower 12, the operator can maneuver the safety latch release spring 210 so that the handle 220 is moved from the second aperture leg 226 to the first aperture leg 224. This movement will cause the spring 210 to exert forces on the safety latch pin 232. If the mower 12 is then moved slightly forward, the spring 210 will force the safety latch pin 232 upwardly, allowing the safety latch 228 to slide over the safety notches 206 and 208. When the safety latch 228 has been disengaged from the safety notches 206, 208, the operator can then move the mower 12 in reverse. Such movement will cause the arcuate lift arm 182 to move from a full over position (shown in FIG. 18) to a lower position. Further reversal of the mower 12 will cause the pivot pin 196 to be disengaged from the arcuate sockets 112.

In accordance with the foregoing, a pivot lift assembly 100 in accordance with the invention has been described for assistance in performing maintenance on vehicles such as commercial mowers. The lift assembly 100 is a device which may be mounted on the floor, and will automatically lift the front of a mower when the mower is driven into engagement with the lift arm. The lift system 100 will raise the front of the mower for purposes of easy access to blades and the like. A safety latch configuration provides for engagement in one of two releasably locked positions (with the positions causing the mower to be lifted to different heights), thereby ensuring the safety of those performing maintenance under the mower.

It should be understood that the foregoing is merely exemplary of the preferred practice of the present invention and that various changes and modifications may be made in the arrangements and details of construction of the present invention without departing from the spirit and scope thereof.

I claim:

1. A pivot lift for raising a riding lawnmower or other small vehicle to an elevated position comprising:
a base mounting plate attachable in a fixed position to a floor, a movable mounting member such as a sheet of flat board, or a bed of a pickup truck or the like;
a base that removably is connectable to the base mounting plate and resists tipping or sliding rearwardly when mounted;
a lift arm pivotally mounted in the base for movement between lowered and raised positions, the lift arm having an offset intermediate portion that extends away from the vehicle being raised;
adjustment means for adjusting the lowered position of the lift arm so that it engages the mounting bracket; and
a mounting bracket attached to the vehicle having an inclined pivot pin engaging surface leading to a socket, with the bracket also having an inclined surface on the opposite side of the socket, the bracket being attachable to vehicles having no integral mounting bracket by means of a shaft that is removably attachable to the vehicle, with the use of attachment brackets attachable to the vehicle if necessary.
